(19) United States
(12) Patent Application Publication
(10) Pub. No.: US 2016/0275245 A1
(43) Pub. Date: Sep. 22, 2016

(54) ITERATIVE CONSTRUCTION OF CLINICAL HISTORY SECTIONS

(71) Applicant: KONINKLIJKE PHILIPS N.V., Eindhoven (NL)

(72) Inventors: MERLIJN SEVENSTER, Chicago, IL (US); YUECHEN QIAN, Briarcliff Manor, NY (US)

(21) Appl. No.: 15/035,613

(22) PCT Filed: Nov. 4, 2014
(86) PCT No.: PCT/IB2014/065778

§ 371 Date: May 10, 2016

Related U.S. Application Data
(60) Provisional application No. 61/908,894, filed on Nov. 26, 2013.

(51) Int. Cl. G06F 19/00; G06F 17/30

(52) U.S. Cl. CPC G06F 19/321; G06F 17/30864

(57) ABSTRACT

A system for generating a patient clinical history for a current exam includes a clinical information database containing one or more clinical documents. Each clinical document including a list of patient specific information items. A clinical information crawler engine queries the clinical information database for clinical data, the clinical data including one or more information items. A clinical history construction interface displays the clinical data to the user. A narrative construction engine concatenates information items within the clinical data selected in the clinical history construction interface by the user and creates a free-text rendering, wherein the free-text rendering is inserted into the patient clinical history of a clinical report.

The present application relates generally to an iterative construction of clinical histories. It finds particular application in conjunction with presenting information items to a user from which the user can intuitively create a clinical history section that can subsequently be rendered as free text and inserted as such in the radiology report and will be described with particular reference thereto. However, it is to be understood that it also finds application in other usage scenarios and is not necessarily limited to the aforementioned application.

Radiologists, like other medical specialists, must keep up-to-date, detailed files on their patient's medical histories. In doing so, radiologists write a clinical history section in each report that reflects the current and prior health status of the patient as well as reasons for the exam. Writing a clinical history section is labor intensive and therefore time consuming. It requires the radiologists to synthesize information from multiple sources into one coherent narrative and oftentimes radiologists, like other medical specialists, are overwhelmed by continuously increasing amounts of information available per patient, and sometimes, will simply not put any effort in writing a clinical history section. However, the failure to write a detailed narrative of each patient's visit and findings has been recognized to adversely affect the radiologist's understanding of the patient's condition and will therefore reduce the value of the radiologist's interpretation of the image.

The present application provides new and improved methods and systems which overcome the above-referenced problems and others.

In accordance with one aspect, a system for generating a patient clinical history for a current exam is provided. The system including a clinical information database containing one or more clinical documents, each clinical document including a list of patient specific information items. A clinical information crawler engine queries the clinical information database for clinical data, the clinical data including one or more information items. A clinical history construction interface displays the clinical data to the user. A narrative construction engine concatenates information items within the clinical data selected in the clinical history construction interface by the user and creates a free-text rendering, wherein the free-text rendering is inserted into the patient clinical history of a clinical report.

In accordance with another aspect, a method for generating a patient clinical history is provided. The method including querying a clinical information database containing one or more clinical documents, each clinical document including a list of patient specific information items, displaying the specific patient information items to the user via a clinical history construction interface, concatenating information items selected by the user in the clinical history construction interface, and creating a free-text rendering of the selected information item which is inserted into the patient clinical history of a clinical report.

In accordance with another aspect, a system for generating a patient clinical history is provided. The system including one or more processor programmed to query a clinical information database containing one or more clinical documents, each clinical document including a list of patient specific information items, display the specific patient information items to the user via a clinical history construction interface, concatenate information items selected by the user in the clinical history construction interface, and create a free-text rendering of the selected information item which is inserted into the patient clinical history of a clinical report.

One advantage resides in the reduction in time spent by the radiologist or other medical professional to generate a thorough clinical history for a patient.

Another advantage resides in the ability to add, remove, or move around information included in the clinical history report.

Another advantage resides in generating relevant and thorough clinical history reports for each patient based on information from previous related and unrelated exams

Another advantage resides in improved clinical workflow.

Another advantage resides in improved patient care.

Still further advantages of the present invention will be appreciated to those of ordinary skill in the art upon reading and understanding the following detailed description.

The invention may take form in various components and arrangements of components, and in various steps and arrangement of steps. The drawings are only for purposes of illustrating the preferred embodiments and are not to be construed as limiting the invention.

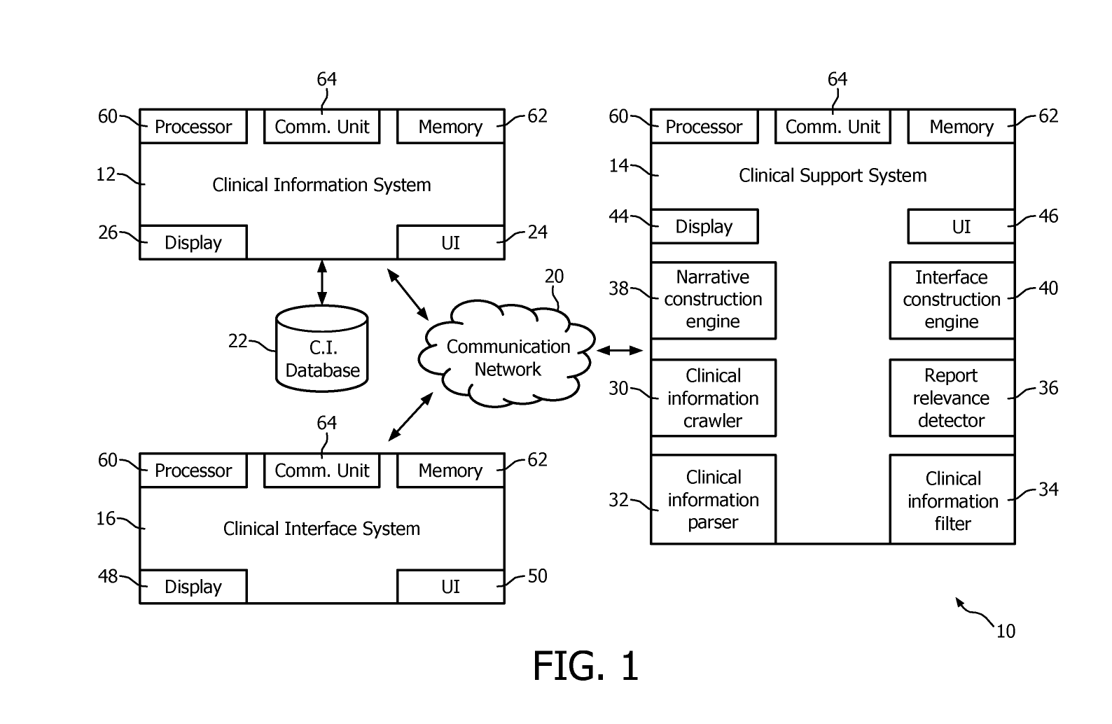

FIG. 1 illustrates a block diagram of an IT infrastructure of a medical institution according to aspects of the present application.

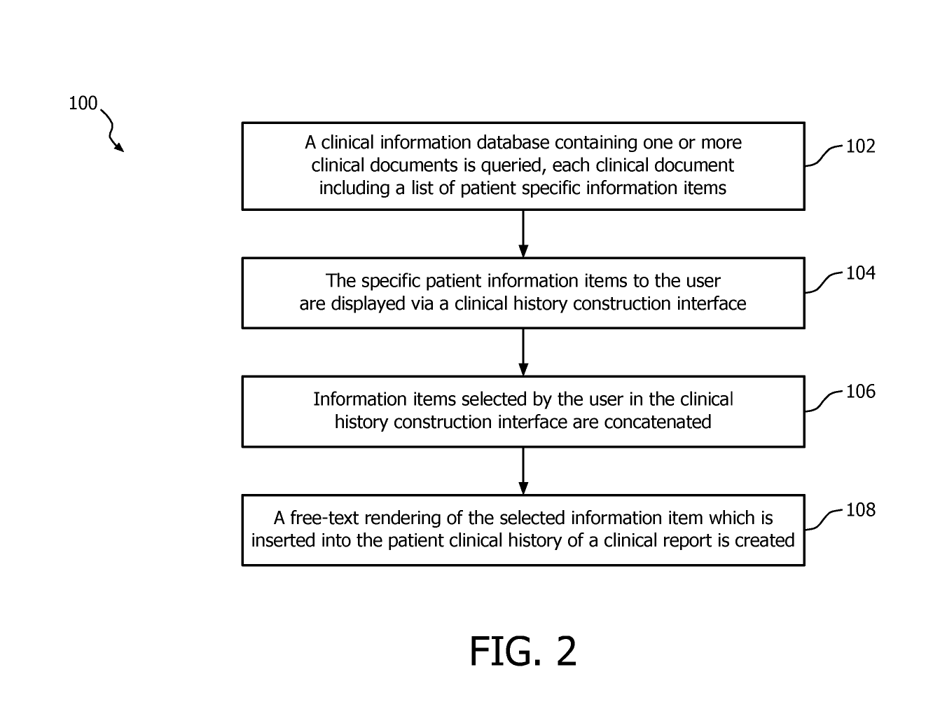

FIG. 2 illustrates a flowchart diagram of a method for iterative construction of clinical histories according to aspects of the present application.

The present application is directed to a system and method for presenting clinical information items to a user from which he/she can intuitively create a clinical history section that can subsequently be rendered as free text and inserted as such in a clinical document. The present application is inspired by the insight that the clinical history of the most recent prior clinical document is a useful basis for the clinical history of the current study. Specifically, the current clinical history only needs to be augmented with the information residing in resources that were created since the most recent prior clinical document. The present application will assist radiologists by saving time from browsing disparate information systems and synthesizing multiple information items into on coherent clinical history section.

The present application is based on the key notion that the clinical history section of the most recent prior clinical document summarizes the health status of the patient up to that point in time. The clinical history section of the current exam's clinical document can thus copy the clinical history section from the most recent prior clinical document possibly augmented with information that have become available in the time interval between the most recent prior and the current exam. The present application utilizes this insight by letting the user select pertinent information items from the prior clinical history section and other information sources that have become available. For example, if the patient has a patient is considered high risk for breast cancer, this may have been indicated in her most recent breast cancer screening MRI exam, e.g., “family history of breast cancer”. If the patient presents for an x-ray to rule out pneumonia, this information may not be available to the radiologist when he/she writes the clinical history section (unless he opens the most recent prior MRI, which he is unlikely to do, as it is an unrelated exam). The present application provides the user the information item including the string “family history of breast cancer” which he/she can choose to incorporate in the clinical history section of the x-ray exam.

With reference to FIG. 1, a block diagram illustrates one embodiment of an IT infrastructure 10 of a medical institution, such as a hospital. The IT infrastructure 10 suitably includes a clinical information system 12, a clinical support system 14, clinical interface system 16, and the like, interconnected via a communications network 20. It is contemplated that the communications network 20 includes one or more of the Internet, Intranet, a local area network, a wide area network, a wireless network, a wired network, a cellular network, a data bus, and the like. It should also be appreciated that the components of the IT infrastructure be located at a central location or at multiple remote locations.

The clinical information system 12 stores clinical documents including radiology reports, pathology reports, lab reports, lab/imaging reports, electronic health records, EMR data, and the like in a clinical information database 22. A clinical document may comprise documents with clinical data relating to an entity, such as a patient. The clinical history section of the most prior recent clinical document is constructed from this list of information items by means of sorting and concatenation. The list of information items may, however, contain more items (possibly tagged with meta-data) than are strictly necessary to construct the clinical history section. Some of the clinical documents may be free-text documents, whereas other documents may be structured document. Such a structured document may be a document which is generated by a computer program, based on data the user has provided by filling in an electronic form. For example, the structured document may be an XML document. Structured documents may comprise free-text portions. Such a free-text portion may be regarded as a free-text document encapsulated within a structured document. Consequently, free-text portions of structured documents may be treated by the system as free-text documents. Each of the clinical documents contains a list of information items. The list of information items including strings of free text, such as phases, sentences, paragraphs, words, and the like. The information items of the clinical documents can be generated automatically and/or manually. For example, various clinical systems automatically generate information items from previous clinical documents, dictation of speech, and the like. As to the latter, user input devices 24 can be employed. In some embodiments, the clinical information system 12 include display devices 26 providing users a user interface within which to manually enter the information items and/or for displaying clinical documents. In one embodiment, the clinical documents are stored locally in the clinical information database 22. In another embodiment, the clinical documents are stored nationally or regionally in the clinical information database 22. Examples of patient information systems include, but are not limited to, electronic medical record systems, departmental systems, and the like.

The clinical support system 14 assists the user by providing information items to the user from which he can intuitively create a clinical history that can subsequently be rendered as free text and inserted as such in a radiology report. Specifically, the clinical supports system 14 queries the clinical information system 12 for clinical data within the information items that has become available between the date of the most recent prior clinical document and the date of the current study. The clinical support system 14 further parses clinical documents and detects phrases in sentences/paragraphs that are potentially pertinent to creating a clinical history. The clinical support system 14 additionally generates a user interface in which all clinical information items pertaining to one patient is presented to the user. The clinical information items selected by the user are then utilized to create a free-text rendering of the clinical history. The clinical support system 14 includes a display 44 such as a CRT display, a liquid crystal display, a light emitting diode display, to display the information items and a user input device 46 such as a keyboard and a mouse, for the clinician to input and/or modify the provided information items.

Specifically, the clinical support system 14 includes a clinical information crawling engine 30 which queries the clinical information system 12 for information items containing clinical data which have become available between the date of the most recent prior clinical document and the date of the current study. The clinical information crawling engine 30 also retrieves the information items from the clinical information system 12 in which pertinent clinical data is stored. Using standard application programming interface techniques, the clinical information crawling engine 30 queries the clinical information system 12 utilizing patient-specific identifiers (MRN). As mentioned above, the clinical information system 12 contains various types of dated information such as radiology, pathology, lab and post-op reports, imaging/test orders, in addition to other types of dated information that is (not necessarily) stored in the form of legal report documents, such as allergies, problem list, medication lists and reason for study. The clinical information crawling engine 30 further detects if the date of the information is within the time interval spanned between the most recent prior clinical document and the current study.

The clinical support system also includes a clinical information parser engine 32 that parses clinical documents. Specifically, the clinical information parser engine 32 processes the clinical documents to detect information items in the clinical documents and to detect a pre-defined list of pertinent findings. To accomplish this, the clinical information parser engine 32 segments the clinical documents into information items including sections, paragraphs, sentences, words, and the like. Typically, clinical documents contain a time-stamped header with protocol information in addition to clinical history, techniques, comparison, findings, impression section headers, and the like. The content of sections can be easily detected using a predefined list of section headers and text matching techniques. Alternatively, third party software methods can be used, such as MedLEE. For example, if a list of pre-defined terms is given, string matching techniques can be used to detect if one of the terms is present in a given information item. The string matching techniques can be further enhanced to account for morphological and lexical variant and for terms that are spread over the information item. If the pre-defined list of terms contains ontology IDs, concept extraction methods can be used to extract concepts from a given information item. The IDs refer to concepts in a background ontology, such as SNOMED or RadLex. For concept extraction, third-party solutions can be leveraged, such as MetaMap. Further, natural language processing techniques are known in the art per se. It is possible to apply techniques such as template matching, and identification of instances of concepts, that are defined in ontologies, and relations between the instances of the concepts, to build a network of instances of semantic concepts and their relationships, as expressed by the free text.

The clinical information filter engine 34 of the clinical support system 14 detects phrases in the information items that are potentially pertinent to creating a clinical history. The clinical information filter engine 34 detects pertinent information in given information items, such as sentences, phrases, or paragraphs. In one embodiment, the clinical information filter engine 34 checks if one or more of a pre-defined list of keywords is in the information items, accounting for lexical variants. In another embodiment, the clinical information filter engine 34 extracts clinical concepts from the information items and matches the extracted clinical concepts against a list of flagged concepts. In yet another embodiment, the clinical information filter engine 34 extracts the clinical concept first and then checks if any of the extracted clinical concepts have a particular relation with one of a list of flagged concepts. In this manner, the clinical information filter engine 34 specifies that all concepts related to cancer are of importance, and that, by extension, all information items containing cancer-related terminology should be flagged as relevant clinical information item.

The clinical support system 14 also includes a report relevance detector engine 36 that checks the relevance of the most recent prior clinical document to the current clinical study. The report relevance detector engine 36 accomplishes this by matching the DICOM BodyPart and/Modality attributes of the most recent prior clinical document to the current study. Furthermore, matching can be done utilizing the DICOM study description/code attributes of the most recent prior clinical document to the current study. It should also be appreciated that hospitals may use codes to label studies like screening, oncology cases and the like in which the study description may contain special anatomy under investigation. If the most recent prior clinical document is relevant to the current study, no further action will be taken by the report relevance detector engine 36. Otherwise, the report relevance detector engine 36 will process the other previous clinical document of the patient until a relevant clinical document if any is found. In the case the most recent clinical document is not relevant to the current study; the report relevance detector engine 36 retrieves the most recent relevant prior clinical document. In another embodiment, the report relevance detector engine 36 determines which prior clinical document counts as the most recent relevant prior exam. For example, report relevance detector engine 36 determines the most recent relevant prior exam by analyzing the date, modality, anatomy, and other meta-data associated with the clinical document.

The clinical support system also includes a clinical history construction interface engine 40 which generates a user interface in which the pertinent clinical information items corresponding to one patient is presented to the user. The displayed information items encompass the information items in the prior clinical history section in the most recent clinical document as well as the ones retrieved by the clinical information crawler engine 30. The user interface generated by the clinical history construction interface engine 40 enables the user to select and/or manipulate the information items with the aim of constructing a clinical history section for the current study. The information items selected and/or manipulated by the user resulting in the clinical history section are stored and flagged in the clinical information system 12. The clinical history construction interface engine 40 also utilizes visualization techniques so that the source of the information items can be distinguished by the user. For example, the clinical history construction interface engine 40 utilizing the color black if the information item appeared in the clinical history section of the most recent prior clinical document; the clinical history construction interface engine 40 utilizes the color red if it appeared in a pathology report that appeared since; the clinical history construction interface engine 40 utilizes the color green if it appeared in the reason for exam of the current exam; the clinical history construction interface engine 40 utilizes the color brown if it appeared in a prior clinical document, and the like. It should be appreciated that the clinical history construction interface engine 40 provides the information items in multiple windows or panes. In this manner, the information items that appeared in the most recent clinical history section can be separated from information items that were flagged as “suppressed” or that were extracted by the clinical information filter engine 34 from radiology/pathology/lab/etc. The user interface generated by the clinical history construction interface engine 40 also enables various ways of manipulating the content. For instance, the generated user interface enables the user to change the order of information items by dragging and dropping. The user interface also enables the user to suppress an information item by clicking on it, or on a button that appears close to it (when the user moves the mouse close to it). The user interface further enables the user to remove the information item by clicking on it twice. The generated user interface also enables the user to create new information items as well as drag an information item from one pane to the other.

The clinical support system 14 further includes a narrative construction engine 38 which accepts the information items selected and ordered by the user in the clinical history construction interface engine 40 and creates a free-text rendering for a current clinical history section. This free-text narrative can be inserted in the clinical history section of the current clinical document. In certain cases, it may be useful to insert headers or dates. In this manner, the narrative construction engine 38 inserts a header: “From recent clinical document (dated Jan. 2, 2013): . . . ” where “ . . . ” contains the information item(s) extracted from a clinical document that has been authored since the most recent prior clinical document. The narrative construction engine 38 may use customizable style sheets that can be tweaked and personalized by each user.

The clinical interface system 16 provides the generated user interface that presents information items to the user from which he/she can intuitively create a clinical history section that can subsequently be rendered as free text and inserted as such in a clinical document. The clinical interface system 16 receives the user interface and displays the view to the caregiver on a display 48. The clinical interface system 16 also includes a user input device 50 such as a touch screen or keyboard and a mouse, for the clinician to input and/or modify the user interface views. Examples of caregiver interface system include, but are not limited to, personal data assistant (PDA), cellular smartphones, personal computers, or the like.

The components of the IT infrastructure 10 suitably include processors 60 executing computer executable instructions embodying the foregoing functionality, where the computer executable instructions are stored on memories 62 associated with the processors 60. It is, however, contemplated that at least some of the foregoing functionality can be implemented in hardware without the use of processors. For example, analog circuitry can be employed. Further, the components of the IT infrastructure 10 include communication units 64 providing the processors 60 an interface from which to communicate over the communications network 20. Even more, although the foregoing components of the IT infrastructure 10 were discretely described, it is to be appreciated that the components can be combined.

With reference to FIG. 2, a flowchart diagram 100 of a method for iterative construction of clinical histories is illustrated. Although each of the blocks in the diagram is described sequentially in a logical order, it is not to be assumed that the system processes the described information in any particular order or arrangement. In a step 102, a clinical information database containing one or more clinical documents is queried, each clinical document including a list of patient specific information items. In a step 104, the specific patient information items to the user are displayed via a clinical history construction interface. In a step 106, information items selected by the user in the clinical history construction interface are concatenated. In a step 108, a free-text rendering of the selected information item which is inserted into the patient clinical history of a clinical report is created.

As used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet/Intranet server from which the stored instructions may be retrieved via the Internet/Intranet or a local area network; or so forth. Further, as used herein, a processor includes one or more of a microprocessor, a microcontroller, a graphic processing unit (GPU), an application-specific integrated circuit (ASIC), a field-programmable gate array (FPGA), personal data assistant (PDA), cellular smartphones, mobile watches, computing glass, and similar body worn, implanted or carried mobile gear; a user input device includes one or more of a mouse, a keyboard, a touch screen display, one or more buttons, one or more switches, one or more toggles, and the like; and a display device includes one or more of a LCD display, an LED display, a plasma display, a projection display, a touch screen display, and the like.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A system for generating a patient clinical history for a current exam, the system comprising:
a clinical information database containing one or more clinical documents, each clinical document including a list of patient specific information items;
a clinical information crawler engine for querying the clinical information database for clinical data, the clinical data including one or more information items;
a clinical history construction interface for displaying the clinical data to the user; and
a narrative construction engine that concatenates information items within the clinical data selected in the clinical history construction interface by the user and creates a free-text rendering, wherein the free-text rendering is inserted into the patient clinical history of a clinical report,
characterized by
further including a relevancy engine that detects date information and current clinical diagnosis information from the information items for inclusion in the patient clinical history section including:
a memory for storing attributes of prior clinical documents;
a processor for extracting information from the current clinical report; and
a relevancy checking processor for comparing a most recent prior clinical document with the current clinical report, wherein if the attributes do not match further clinical date compared.

2. The system according to claim 1, wherein the clinical information crawler engine detects if the date of the information item is within the time interval spanned between the most recent relevant prior exam and the current exam.

3. The system according to claim 1, wherein the clinical history construction interface displays at least one of: one or more information items from a prior clinical history and/or one or more information items identified by the clinical information crawler engine.

4. The system according to claim 3, wherein the user manipulates the one or more information items in the clinical history construction interface to construct a patient clinical history for the current exam.

5. The system according to claim 4, wherein the information items that construct a patient clinical history are flagged in the clinical information database.

6. The system according to claim 1, further including:
a parsing engine that parses clinical documents including:
a memory for storing natural language information;
a processor that receives the information items identified by the clinical information crawler engine from the clinical document stored in the clinical information database;
a processor for comparing the information items in the processor with the information stored in memory; and
a communication unit for communicating the parsed clinical information to the patient clinical story.

7. The system according to claim 6, wherein the parsing engine recognizes sections; paragraphs, and sentences.

8. The system according to claim 1, further including:
a filtering engine that filters phrases in the clinical data of the information database systems for inclusion in the patient clinical history section including:
a memory for storing a list of keywords;
a processor for extracting information items from the clinical report; and
a filter for comparing the extracted information items with the list of keywords, wherein matching extracted information items are included in the patient clinical history.

9. The system according to claim 8, wherein the filter of the filtering engine extracts concepts from the free-text rendering generated by the narrative construction engine and matches the extracted concepts against a list of flagged concepts, wherein matching flagged concepts are included in the patient clinical history.

10. The system according to claim 8, wherein the filter of the filtering engine extracts concepts from the free-text rendering generated by the narrative construction engine and compares the extracted concepts against a list of relevant flagged concepts, wherein matching extracted concepts are flagged relevant and are included in the patient clinical history.

11. (canceled)

12. A method for generating a patient clinical history, the method comprising:
querying a clinical information database containing one or more clinical documents, each clinical document including a list of patient specific information items;
displaying the specific patient information items to the user via a clinical history construction interface;
concatenating information items selected by the user in the clinical history construction interface; and
creating a free-text rendering of the selected information item which is inserted into the patient clinical history of a clinical report
characterized by
further including a relevancy step of detecting data information and current clinical diagnosis information from the information items for inclusion in the patient clinical history section, the relevancy step including:
extracting information from the current clinical report; and
comparing a most recent prior clinical document, attributes of which being stored in a memory, with the current clinical report, wherein if the attributes do not match further clinical date compared.

13. The method according to claim 12, further including:
detecting if the date of the information item is within the time interval spanned between the most recent relevant prior exam and the current exam.

14. The method according to claim 12,
wherein the user manipulates the one or more information items in the clinical history construction interface to construct a patient clinical history for the current exam

15. The method according to claim 12, further including:
displaying at least one of one or more information items from a prior clinical history and one or more information items identified in the querying.

16. (canceled)

17. (canceled)

18. (canceled)

19. (canceled)
